(19) United States
(12) Patent Application Publication
(10) Pub. No.: US 2015/0333362 A1
(43) Pub. Date: Nov. 19, 2015

(54) LITHIUM ION SECONDARY BATTERY

(71) Applicant: TDK CORPORATION, Tokyo (JP)

(72) Inventors: Hiroshi SATO, Tokyo (JP); Tetsuya UENO, Tokyo (JP); Ayaka HORIKAWA, Tokyo (JP); Keitaro OTSUKI, Tokyo (JP)

(21) Appl. No.: 14/707,361

(22) Filed: May 8, 2015

(30) Foreign Application Priority Data
May 19, 2014 (JP) 2014-103038
Apr. 15, 2015 (JP) 2015-083428

(51) Int. Cl. H01M 10/052; H01M 4/58; H01M 10/0562

(52) U.S. Cl. CPC H01M 10/052; H01M 10/0562; H01M 4/5825; H01M 2300/0068

(57) ABSTRACT

A lithium ion secondary battery including a positive electrode layer, a negative electrode layer, and a solid electrolyte layer is provided. The positive electrode layer includes a positive electrode current collector layer and a positive electrode active material layer. The positive electrode active material layer includes a positive electrode active material. The negative electrode layer includes a negative electrode current collector layer and a negative electrode active material layer. The negative electrode active material layer includes a negative electrode active material. The solid electrolyte layer between the positive and negative electrode active material layers includes a solid electrolyte. At least one of a ratio of a particle diameter of the solid electrolyte to a particle diameter of the positive electrode active material and a ratio of the particle diameter of the solid electrolyte to a particle diameter of the negative electrode active material ranges from 3.0 to 10.0.

### CROSS-REFERENCE TO RELATED APPLICATION

This application claims priority from Japanese Patent Applications No. 2014-103038 filed May 19, 2014 and No. 2015-083428 filed Apr. 15, 2015 with the Japan Patent Office, the entire contents of which are hereby incorporated by reference.

### BACKGROUND

1. Technical Field

The present disclosure relates to a lithium ion secondary battery.

2. Related Art

Electronics techniques have made remarkable advances in recent years. Portable electronic appliances have achieved reduction in size, weight, and thickness and increase in functionality. Along with this, the battery used as a power source of the electronic appliance has been strongly desired to have smaller size, weight, and thickness and higher reliability. In view of this, an all-solid lithium ion secondary battery including a solid electrolyte layer having a solid electrolyte has attracted attention.

In general, all-solid lithium ion secondary batteries are classified into two types of a thin-film type and a bulk type. The thin-film type is manufactured by a thin-film technique such as a PVD method or a sol-gel method. The bulk type is manufactured by powder compacting of an active material or a sulfide-based solid electrolyte with low grain-boundary resistance. As for the thin-film type, it is difficult to increase the thickness of the active material layer and to increase the number of layers. This results in problems that the capacity is low and the manufacturing cost is high. On the other hand, the bulk type employs the sulfide-based solid electrolyte. The sulfide-based solid electrolyte reacts with water to generate hydrogen sulfide. In view of this, it is necessary to manufacture the battery in a glove box with a managed dew point. Moreover, it is difficult to make the solid electrolyte layer into sheet. Thus, decreasing the thickness of the solid electrolyte layer and increasing the number of layers of the battery have been an issue.

In view of the above circumstances, Japanese Domestic Re-publication of PCT International Publication No. 07-135790 describes the all-solid battery manufactured by the industrially applicable manufacturing method that enables the mass production. This all-solid battery is manufactured by stacking members made into sheets using the oxide-based solid electrolyte, which is stable in the air, and firing the members at the same time. However, since the different kinds of materials are fired at the same time, the contact area between the solid electrolyte layer and the positive and negative electrode layers is small. Therefore, it has been a problem that the interface resistance of the lithium ion secondary battery is high.

### SUMMARY

The lithium ion secondary battery according to the embodiment of the present disclosure includes a positive electrode layer, a negative electrode layer, and a solid electrolyte layer. The positive electrode layer includes a positive electrode current collector layer and a positive electrode active material layer. The positive electrode active material layer includes a positive electrode active material. The negative electrode layer includes a negative electrode current collector layer and a negative electrode active material layer. The negative electrode active material layer includes a negative electrode active material. The solid electrolyte layer is positioned between the positive electrode active material layer and the negative electrode active material layer and includes a solid electrolyte. At least one of a ratio of a particle diameter of the solid electrolyte to a particle diameter of the positive electrode active material and a ratio of the particle diameter of the solid electrolyte to a particle diameter of the negative electrode active material is in the range of 3.0 to 10.0.

### BRIEF DESCRIPTION OF DRAWINGS

FIG. 1 is a sectional view illustrating a conceptual structure of a lithium ion secondary battery.

FIG. 2 is a Scanning Electron Microscope (SEM) photograph of a cross section of a lithium ion secondary battery, which is to be calcinated, of embodiments 1-4.

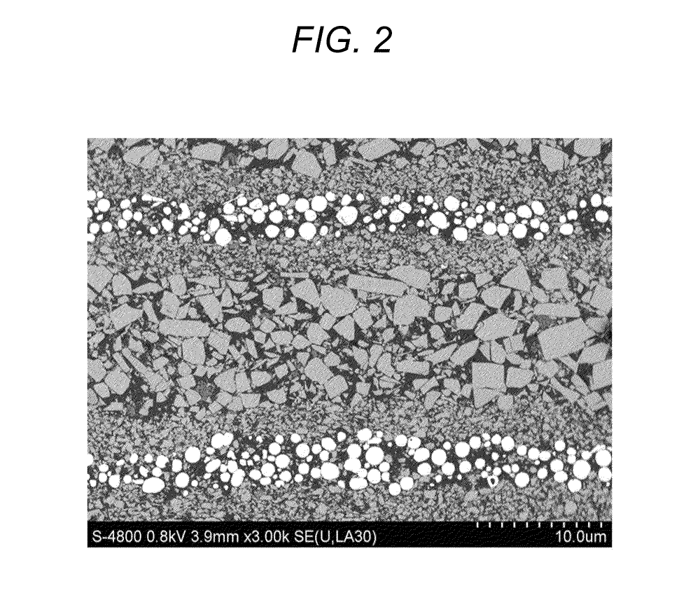

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure for solving the above conventional problem is to reduce the interface resistance between the positive electrode active material layer and the solid electrolyte layer and the interface resistance between the negative electrode active material layer and the solid electrolyte layer in the lithium ion secondary battery.

In order to solve the above described problem, the lithium ion secondary battery according to the embodiment of the present disclosure includes a positive electrode layer, a negative electrode layer, and a solid electrolyte layer. The positive electrode layer includes a positive electrode current collector layer and a positive electrode active material layer. The positive electrode active material layer includes a positive electrode active material. The negative electrode layer includes a negative electrode current collector layer and a negative electrode active material layer. The negative electrode active material layer includes a negative electrode active material. The solid electrolyte layer is positioned between the positive electrode active material layer and the negative electrode active material layer and includes a solid electrolyte. At least one of a ratio of a particle diameter of the solid electrolyte to a particle diameter of the positive electrode active material and a ratio of the particle diameter of the solid electrolyte to a particle diameter of the negative electrode active material is in the range of 3.0 to 10.0.

In the lithium ion secondary battery according to the embodiment of the present disclosure, the positive electrode active material and the negative electrode active material with small particle diameters are disposed between the solid electrolyte. This increases the contact area between the positive electrode active material and the solid electrolyte, and the contact area between the negative electrode active material and the solid electrolyte. Therefore, the interface resistance between the positive electrode active material layer and the solid electrolyte layer and the interface resistance between the negative electrode active material layer and the solid electrolyte layer in the lithium ion secondary battery can be reduced.

In the above disclosed lithium ion secondary battery, the solid electrolyte layer includes Li₁₊ₓAlₓTi₂₋ₓ(PO₄)₃ (0≦x≦0.6) and the positive electrode active material layer may include at least one of LiVOPO₄ and Li₃V₂(PO₄)₃. Moreover, in the above disclosed lithium ion secondary battery, the solid electrolyte layer includes Li₁₊ₓAlₓTi₂₋ₓ(PO₄)₃ (0≦x≦0.6); and the negative electrode active material layer may include at least one of LiVOPO₄ and Li₃V₂(PO₄)₃. In the above disclosed lithium ion secondary battery, the solid electrolyte layer includes Li₁₊ₓAlₓTi₂₋ₓ(PO₄)₃ (0≦x≦0.6); and the positive electrode active material layer and the negative electrode active material layer may include at least one of LiVOPO₄ and Li₃V₂(PO₄)₃.

In the structure as above, at least one of titanium and aluminum is diffused in vanadium lithium phosphate. Therefore, the bond at the interface between the solid electrolyte layer and at least one of the positive electrode active material layer and the negative electrode active material layer becomes firm. Therefore, the effect is obtained that reduces the interface resistance between the solid electrolyte layer and at least one of the positive electrode active material layer and the negative electrode active material layer of the lithium ion secondary battery.

According to the embodiment of the present disclosure, the lithium ion secondary battery with low interface resistance between the solid electrolyte layer and the positive electrode active material layer and/or the negative electrode active material layer can be provided.

An embodiment of the present disclosure is hereinafter described with reference to the drawings. Note that the lithium ion secondary battery of the present disclosure is not limited to the embodiment below. The component described below includes another component that is easily conceived by a person skilled in the art and the component that is substantially the same as the described component. The components in the description below can be used in combination as appropriate.

### (Structure of Lithium Ion Secondary Battery)

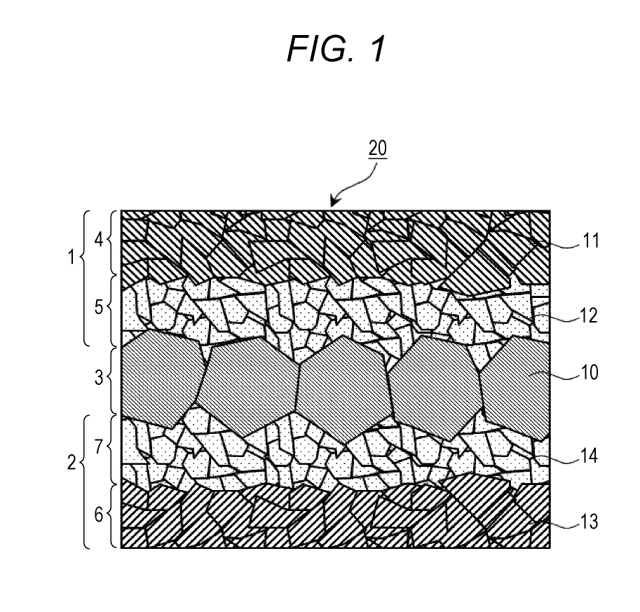

FIG. 1 is a sectional view illustrating a conceptual structure of a lithium ion secondary battery 20 according to this embodiment. The lithium ion secondary battery 20 according to this embodiment is formed by stacking a positive electrode layer 1 and a negative electrode layer 2 with a solid electrolyte layer 3 interposed therebetween. The positive electrode layer 1 includes a positive electrode current collector layer 4 and a positive electrode active material layer 5. The negative electrode layer 2 includes a negative electrode current collector layer 6 and a negative electrode active material layer 7. The solid electrolyte layer 3 includes a solid electrolyte 10. The positive electrode current collector layer 4 includes a positive electrode current collector 11. The positive electrode active material layer 5 includes a positive electrode active material 12. The negative electrode current collector layer 6 includes a negative electrode current collector 13. The negative electrode active material layer 7 includes a negative electrode active material 14. In the description below, “active materials 12, 14” may refer to either or both of the positive electrode active material 12 and the negative electrode active material 14. Further, “active material layers 5, 7” may refer to either or both of the positive electrode active material layer 5 and the negative electrode active material layer 7. In addition, “electrode” may refer to either or both of the positive electrode and the negative electrode.

As illustrated in FIG. 1, the positive electrode active material 12 and the negative electrode active material 14 with small particle diameters are disposed between the solid electrolyte 10 as long as the ratio of the particle diameter of the solid electrolyte 10 to the particle diameter of the active materials 12, 14 (i.e., (particle diameter of solid electrolyte 10)/(particle diameter of positive electrode active material 12) and/or (particle diameter of solid electrolyte 10)/(particle diameter of negative electrode active material 14) is 3.0 to 10.0. Thus, the contact area between the active materials 12, 14 and the solid electrolyte 10 is increased. As a result, the interface resistance between the active material layers 5, 7 and the solid electrolyte layer 3 of the lithium ion secondary battery 20 can be reduced.

The ratio of the particle diameter of the solid electrolyte 10 to the particle diameter of the active materials 12, 14 (hereinafter referred to as “particle diameter ratio”) may be in the range of 3.0 to 10.0 after firing. Thus, the particle diameter ratio before firing is not limited to the above range. As long as it is known that there is a good correlation between the particle diameter ratios before and after firing, the particle diameter ratio before firing may be in the range of 3.0 to 10.0 already. Alternatively, the particle diameter ratio can be controlled by adding a sintering aid or controlling a firing condition.

The particle diameters of the solid electrolyte 10, the positive electrode active material 12, and the negative electrode active material 14 of the lithium ion secondary battery 20 of this embodiment can be obtained by analyzing the sectional image of the lithium ion secondary battery 20 taken with a scanning electron microscope or the like. In other words, assuming that the shape of the particle in the image is a circle, the diameter of the circle, i.e., the equivalent circle diameter, calculated from the area of the circle, may be regarded as the particle diameter. Here, in regard to the number of pieces of data to be measured, 300 pieces is enough from the viewpoint of the reliability of the data. Note that the particle diameter and the average particle diameter in the present disclosure refer to the equivalent circle diameter described above.

FIG. 1 is a sectional view of the lithium ion secondary battery 20 including a pair of positive electrode layer 1 and negative electrode layer 2. The lithium ion secondary battery 20 of this embodiment is, however, not limited to FIG. 1. The lithium ion secondary battery having any number of pairs of stacked positive electrode layers and negative electrode layers is included in the lithium ion secondary battery 20 of this embodiment. Moreover, it is possible to change largely a part of the lithium ion secondary battery 20 in accordance with the specification of the capacity or the current required for the lithium ion secondary battery 20.

### (Solid Electrolyte)

As the solid electrolyte 10 included in the solid electrolyte layer 3 of the lithium ion secondary battery 20 of this embodiment, a material with high lithium ion conductivity and low electron conductivity can be used. For example, at least one kind selected from the group consisting of a perovskite compound such as La_{0.5}Li_{0.5}TiO₃, a LISICON compound such as Li₁₄Zn(GeO₄)₄, a garnet compound such as Li₇La₃Zr₂O₁₂, a NASICON compound such as Li_{1.3}Al_{0.3}Ti_{1.7}(PO₄)₃ and Li_{1.5}Al_{0.5}Ge_{1.5}(PO₄)₃, a thio-LISICON compound such as Li_{3.25}Ge_{0.25}P_{0.75}S₄ and Li₃PS₄, a glass compound such as Li₂S—P₂S₅ and Li₂O—V₂O₅—SiO₂, and a phosphate compound such as Li₃PO₄, Li_{3.5}Si_{0.5}P_{0.5}O₄, and Li_{2.9}PO_{3.3}N_{0.46} can be used. In particular, titanium aluminum lithium phosphate typified by Li₁₊ₓAlₓTi₂₋ₓ(PO₄)₃ (0≦x≦0.6) can be used. Above all, Li₁₊ₓAlₓTi₂₋ₓ(PO₄)₃ (0≦x≦0.6) can be especially used.

The particle diameter of the solid electrolyte 10 included in the solid electrolyte layer 3 in the lithium ion secondary battery 20 of this embodiment may be in the range of 0.2 μm to 4.0 μm. When the diameter is less than or equal to 4.0 μm, it is difficult for the large void to remain in the solid electrolyte layer 3; therefore, the thin and precise solid electrolyte layer 3 can be formed. On the other hand, when the diameter is less than 0.2 μm, the ratio of the grain boundaries is increased. Therefore, due to the interface resistance of the particles, the internal resistance of the lithium ion secondary battery 20 may be increased. Thus, the solid electrolyte 10 with a particle diameter of more than 0.2 μm can be used.

### (Positive Electrode Active Material and Negative Electrode Active Material)

As the positive electrode active material 12 included in the positive electrode active material layer 5 and the negative electrode active material 14 included in the negative electrode active material layer 7 in the lithium ion secondary battery 20 of this embodiment, the material capable of efficient intercalation and deintercalation of lithium ions can be used.

For example, a transition metal oxide and a transition metal composite oxide can be used. Specifically, at least one of lithium manganese composite oxide Li₂Mnₓ₃ Ma₁₋ₓ₃O₃ (0.8≦x3≦1, Ma=Co, Ni), lithium cobaltate (LiCoO₂), lithium nickelate (LiNiO₂), lithium manganese spinel (LiMn₂O₄), composite metal oxides represented by general formula: LiNiₓ₄Co_{y4}Mn_{z4}O₂ (x4+y4+z4=1, 0≦x4≦1, 0≦y4≦1, 0≦z4≦1), a lithium vanadium compound (LiV₂O₅), olivine LiMbPO₄ (wherein Mb represents one or more elements selected from Co, Ni, Mn, Fe, Mg, Nb, Ti, Al, and Zr), vanadium lithium phosphate (Li₃V₂(PO₄)₃ or LiVOPO₄),

Li-excess solid solution positive electrode Li₂MnO₃—LiMcO₂ (Mc=Mn, Co, Ni), lithium titanate (Li₄Ti₅O₁₂), and composite metal oxides represented by LiₐNiₓ₅Co_{y5}Al_{z5}O₂ (0.9<a<1.3, 0.9<x5+y5+z5<1.1) may be used.

Among the above transition metal oxides and transition metal composite oxides, in particular, vanadium lithium phosphate can be used. As the vanadium lithium phosphate, at least one of LiVOPO₄ and Li₃V₂(PO₄)₃ can be used. LiVOPO₄ and Li₃V₂(PO₄)₃ may be lithium-deficient. In particular, LiₓVOPO₄ (0.94≦x≦0.98) and LiₓV₂(PO₄)₃ (2.8≦x≦2.95) can be used.

The material of the positive electrode active material layer 5 and the material of the negative electrode active material layer 7 may be exactly the same. When the above non-polar lithium ion secondary battery is attached to the circuit board, it is not necessary to designate the orientation of the attachment. This leads to the advantage that the mounting speed of the lithium ion secondary battery is improved drastically.

In particular, the bond at the interface between the solid electrolyte layer 10 and the active materials 12, 14 can be made firm when Li₁₊ₓ₂Alₓ₂Ti₂₋ₓ₂(PO₄)₃ (0≦x2≦0.6) is used for the solid electrolyte layer 3 and at least one of LiVOPO₄ and Li₃V₂(PO₄)₃ is used as at least one of the positive electrode active material layer 5 and the negative electrode active material layer 7. Moreover, the contact area at the interface can be expanded.

Moreover, the active materials included in the positive electrode active material layer 5 and the negative electrode active material layer 7 are not clearly distinguished. Out of the two kinds of compounds included in the positive electrode active material layer 5 and the negative electrode active material layer 7, the potentials of the compounds are compared and the compound with nobler potential is used as the positive electrode active material 12 and the compound with baser potential is used as the negative electrode active material 14. The same compound may be used for the positive electrode active material layer 5 and the negative electrode active material layer 7 as long as the compound is capable of intercalation and deintercalation of lithium ions.

The particle diameter of the positive electrode active material 12 included in the positive electrode active material layer 5 and/or the particle diameter of the negative electrode active material 14 included in the negative electrode active material layer 7 in the lithium ion secondary battery 20 of this embodiment may be in the range of 0.2 μm to 3.0 μm. When the diameter is less than or equal to 3.0 μm, it is difficult for the large void to remain in the active material layers 5, 7; therefore, the thin and precise active material layers 5, 7 can be formed. On the other hand, when the diameter is less than 0.2 μm, the ratio of the grain boundaries is increased. Therefore, due to the interface resistance of the particles, the internal resistance of the lithium ion secondary battery 20 may be increased. Thus, the active materials 12, 14 with a particle diameter of more than 0.2 μm can be used.

As described above, in the case of using Li₁₊ₓ₂Alₓ₂Ti₂₋ₓ₂(PO₄)₃ (0≦x2≦0.6) for the solid electrolyte 10 and vanadium lithium phosphate typified by LiVOPO₄ and Li₃V₂(PO₄)₃ for at least one of the positive electrode active material 12 and the negative electrode active material 14, at least one constituent of titanium and aluminum may be distributed in the active material layers 5, 7. The interface resistance between the solid electrolyte layer 3 and the active material layers 5, 7 structured as above is reduced further. As a result, the internal resistance of the lithium ion secondary battery is reduced. Moreover, titanium and/or aluminum (hereinafter referred to as “electrolyte constituent”) may be distributed with gradient in the active material layers 5, 7. Moreover, the concentration of the electrolyte constituent on the side far from the solid electrolyte layer 3 (i.e., closer to the positive electrode current collector layer 4 and/or the negative electrode current collector layer 6) may be lower than the concentration of the electrolyte constituent on the side closer to the solid electrolyte layer 3 in the active material layers 5, 7. In this embodiment, moreover, the electrolyte constituent is distributed to the vicinity of the interface between the positive electrode active material layer 5 and the positive electrode current collector layer 4 and/or the interface between the negative electrode active material layer 7 and the negative electrode current collector layer 6, i.e., across the entire region of the active material layers 5, 7. This can reduce the interface resistance, and moreover reduce the internal resistance of the lithium ion secondary battery.

In the case where both titanium and aluminum are contained in the active material layers 5, 7, the distribution range of titanium and aluminum may be either the same or different. In particular, aluminum may be distributed more widely than titanium. Further, the distribution range may cover the positive electrode current collector layer 4 and/or the negative electrode current collector 6. The interface resistance between the solid electrolyte layer 3 and the active material layers 5, 7 structured as above can be reduced further. This provides the lithium ion secondary battery 20 with reduced internal resistance and excellent reliability.

In this embodiment, by improving the adhesion between the solid electrolyte layer 3 and the active material layers 5, 7, the interface resistance can be reduced further. Therefore, the active material layers 5, 7 with a thickness of 10 μm or less can be used. In particular, the active material layers 5, 7 with a thickness of 5 μm or less can be used.

Moreover, at least one constituent of titanium and aluminum in this embodiment may be distributed to cover the particle surface of the active materials 12, 14 in the active material layers 5, 7.

The at least one constituent may exist even inside the particle of the active materials 12, 14 and moreover may be distributed with the concentration gradient from the surface to the inside of the particle.

The materials included in the solid electrolyte layer 3, the positive electrode active material layer 5, and the negative electrode active material layer 7 in the lithium ion secondary battery 20 of this embodiment can be identified by the X-ray diffraction measurement. The distribution of titanium and aluminum can be analyzed by the EPMA-WDS element mapping, for example.

### (Positive Electrode Current Collector and Negative Electrode Current Collector)

The positive electrode current collector 11 included in the positive electrode current collector layer 4 and the negative electrode current collector 13 included in the negative electrode current collector layer 6 of the lithium ion secondary battery 20 of this embodiment can be formed of the material with high electric conductivity. For example, silver, palladium, gold, platinum, aluminum, copper, and nickel can be used. In particular, copper uneasily reacts with Li₁₊ₓ₂Alₓ₂Ti₂₋ₓ₂(PO₄)₃ (0≦x2≦0.6) of the solid electrolyte 10 and moreover, copper is effective in reducing the internal resistance of the lithium ion secondary battery 20; therefore, copper can be suitably used. The material of the positive electrode current collector 11 may be either the same or different from the material of the negative electrode current collector 13.

The positive electrode current collector layer 4 and the negative electrode current collector layer 6 of the lithium ion secondary battery 20 of this embodiment may include the positive electrode active material 12 and the negative electrode active material 14, respectively. The content ratio of the positive electrode active material 12 and the negative electrode active material 14 in this case is not particularly limited unless the function of the current collector is deteriorated. The volume ratio of the positive electrode current collector 11 to the positive electrode active material 12 and the volume ratio of the negative electrode current collector 13 to the negative electrode active material 14 may be in the range of 90/10 to 70/30.

The adhesion between the positive electrode current collector layer 4 and the positive electrode active material layer 5 and the adhesion between the negative electrode current collector layer 6 and the negative electrode active material layer 7 are improved when the positive electrode current collector layer 4 includes the positive electrode active material 12 and the negative electrode current collector layer 6 includes the negative electrode active material 14.

### (Sintering Aid)

For controlling the particle diameter of the solid electrolyte 10, the positive electrode active material 12, and the negative electrode active material 14 in the lithium ion secondary battery 20 of this embodiment, at least one layer of the solid electrolyte layer 3, the positive electrode active material layer 5, and the negative electrode active material layer 7 may contain a sintering aid. The kind of the sintering aid is not particularly limited. At least one kind selected from the group consisting of lithium oxide, sodium oxide, potassium oxide, boron oxide, silicon oxide, bismuth oxide, and phosphorus oxide can be used.

### (Manufacturing Method for Lithium Ion Secondary Battery)

For manufacturing the lithium ion secondary battery 20 according to this embodiment, first, each material of the positive electrode current collector layer 4, the positive electrode active material layer 5, the solid electrolyte layer 3, the negative electrode active material layer 7, and the negative electrode current collector layer 6, which has been made into a paste, is prepared. Next, these materials are coated and dried, whereby green sheets are manufactured. The obtained green sheets are stacked to manufacture a stacked body, and by firing the stacked body at the same time, the lithium ion secondary battery 20 is manufactured.

A method of making the material into a paste is not limited in particular. For example, the paste can be obtained by mixing the powder of each material in vehicle. Here, the vehicle is a collective term for the medium in a liquid phase. The vehicle includes the solvent and the binder. By this method, the pastes for the positive electrode current collector layer 4, the positive electrode active material layer 5, the solid electrolyte layer 3, the negative electrode active material layer 7, and the negative electrode current collector layer 6 are prepared.

The prepared paste is coated on a base material such as PET (polyethylene terephthalate) in the desired order. Next, the paste on the base material is dried as necessary and then the base material is removed; thus, the green sheet is manufactured. The method of coating the paste is not particularly limited. Any of known methods including the screen printing, the coating, the transcription, and the doctor blade can be used.

A desired number of green sheets can be stacked in the desired order. If necessary, alignment, cutting and the like can be performed to manufacture a stacked body. In the case of manufacturing a parallel type or serial-parallel type battery, the alignment may be conducted when the green sheets are stacked, so that the end face of the positive electrode layer 1 does not coincide with the end face of the negative electrode layer 2.

In order to manufacture the stacked body, the active material unit to be described below may be prepared and the stacking block may be manufactured.

First, the paste for the solid electrolyte layer 3 is formed into a sheet shape on a PET film by the doctor blade method. After the paste for the positive electrode active material layer 5 is printed on the obtained sheet for the solid electrolyte layer 3 by the screen printing, the printed paste is dried. Next, the paste for the positive electrode current collector layer 4 is printed thereon by the screen printing, and then the printed paste is dried. Furthermore, the paste for the positive electrode active material layer 5 is printed again thereon by the screen printing, and the printed paste is dried. Next, by separating the PET film, the positive electrode active material layer unit is obtained. In this manner, the positive electrode active material layer unit in which the paste for the positive electrode active material layer 5, the paste for the positive electrode current collector layer 4, and the paste for the positive electrode active material layer 5 are formed in this order on the sheet for the solid electrolyte layer 3 is obtained. In the similar procedure, the negative electrode active material layer unit is also manufactured. The negative electrode active material layer unit in which the paste for the negative electrode active material layer 7, the paste for the negative electrode current collector layer 6, and the paste for the negative electrode active material layer 7 are formed in this order on the sheet for the solid electrolyte layer 3 is obtained.

One positive electrode active material layer unit and one negative electrode active material layer unit are stacked so that the paste for the positive electrode active material layer 5, the paste for the positive electrode current collector layer 4, the paste for the positive electrode active material layer 5, the sheet for the solid electrolyte layer 3, the paste for the negative electrode active material layer 7, the paste for the negative electrode current collector layer 6, the paste for the negative electrode active material layer 7, and the sheet for the solid electrolyte layer 3 are disposed in this order. On this occasion, the units may be displaced so that the paste for the positive electrode current collector layer 4 of the first positive electrode active material layer unit extends to one end face only and the paste for the negative electrode current collector layer 6 of the second negative electrode active material layer unit extends to the other end face only. On both surfaces of the thusly stacked units, the sheet for the solid electrolyte layer 3 with predetermined thickness is stacked, thereby forming the stacking block.

The manufactured stacking block is crimped at the same time. The crimping is performed while heat is applied. The heating temperature is, for example, 40° C. to 95° C.

The crimped stacking block is fired by being heated at 600° C. to 1000° C. under the nitrogen atmosphere. The firing time is, for example, 0.1 to 3 hours. Through this firing, the stacked body is completed.

### EXAMPLES

### Example 1-1

An embodiment of the present disclosure is hereinafter described with reference to examples. The embodiment of the present disclosure is, however, not limited to these examples. Note that “parts” refer to “parts by mass” unless otherwise stated.

### (Preparation of Positive Electrode Active Material and Negative Electrode Active Material)

As the positive electrode active material and the negative electrode active material, Li₃V₂(PO₄)₃ prepared by the method below was used. First, Li₂CO₃, V₂O₅, and NH₄H₂PO₄ as the starting material were wet mixed for 16 hours using a ball mill. The powder obtained after dehydration and drying was calcined for two hours at 850° C. in a nitrogen-hydrogen mix gas. The calcined product was wet pulverized using a ball mill and then dehydrated and dried, whereby the positive electrode active material powder and the negative electrode active material powder were obtained. The average particle diameter was 0.6 μm. It has been confirmed that the prepared powder had a constituent of Li₃V₂(PO₄)₃ according to the X-ray diffraction apparatus.

### (Preparation of Paste for Positive Electrode Active Material Layer and Paste for Negative Electrode Active Material Layer)

The paste for the positive electrode active material layer and the paste for the negative electrode active material layer were prepared as below. In other words, 15 parts of ethyl cellulose as the binder and 65 parts of dihydroterpineol as the solvent were added to 100 parts of powder of the positive electrode active material and the negative electrode active material and mixed to disperse the powder in the solvent, whereby the paste for the positive electrode active material layer and the paste for the negative electrode active material layer were obtained.

### (Preparation of Paste for Solid Electrolyte Layer)

As the solid electrolyte, Li_{1.3}Al_{0.3}Ti_{1.7}(PO₄)₃ prepared by the method below was used. First, Li₂CO₃, Al₂O₃, TiO₂, and NH₄H₂PO₄ as the starting material were wet mixed for 16 hours using a ball mill. The powder obtained after dehydration and drying was calcined in the air for two hours at 800° C. The calcined product was wet pulverized for 18 hours using a ball mill and then dehydrated and dried, whereby the powder of the solid electrolyte was obtained. The average particle diameter of the powder was 0.6 μm. It has been confirmed that the prepared powder has a constituent of Li_{1.3}Al_{0.3}Ti_{1.7}(PO₄)₃ using the X-ray diffraction apparatus.

Next, this powder was wet mixed with 100 parts of ethanol and 200 parts of toluene as the solvent in the ball mill. After that, 16 parts of polyvinylbutyral binder and 4.8 parts of benzylbutylphthalate were further charged therein and mixed, whereby the paste for the solid electrolyte layer was prepared.

### (Manufacture of Sheet for Solid Electrolyte Layer)

By molding a sheet with the paste for the solid electrolyte layer on a PET film as the base material by a doctor blade method, a sheet for a solid electrolyte layer with a thickness of 15 μm was obtained.

### (Preparation of Paste for Positive Electrode Current Collector Layer and Paste for Negative Electrode Current Collector Layer)

The powder of Cu and Li₃V₂(PO₄)₃ used as the positive electrode current collector and the negative electrode current collector was mixed at a volume ratio of 80/20. After that, 10 parts of ethyl cellulose as the binder and 50 parts of dihydroterpineol as the solvent were added and mixed, whereby the powder was dispersed in the solvent and thus the paste for the positive electrode current collector layer and the paste for the negative electrode current collector layer were obtained. The average particle diameter of Cu was 0.9 μm.

### (Preparation of Terminal Electrode Paste)

By kneading silver powder, epoxy resin, and solvent with a three roll mill, the powder was dispersed in the solvent and a thermosetting terminal electrode paste was obtained.

With the use of these pastes, the lithium ion secondary battery was manufactured as below.

### (Manufacture of Positive Electrode Active Material Unit)

The paste for the positive electrode active material layer with a thickness of 5 μm was printed on the sheet for the above described solid electrolyte layer by the screen printing. The printed paste was dried for 10 minutes at 80° C. Next, the paste for the positive electrode current collector layer with a thickness of 5 μm was printed thereon by the screen printing. The printed paste was dried for 10 minutes at 80° C. The paste for the positive electrode active material layer with a thickness of 5 μm was printed again thereon by the screen printing. The printed paste was dried for 10 minutes at 80° C. Next, the PET film was separated. Thus, the sheet of the positive electrode active material unit was obtained in which the paste for the positive electrode active material layer, the paste for the positive electrode current collector layer, and the paste for the positive electrode active material layer were printed and dried in this order on the sheet for the solid electrolyte.

### (Manufacture of Negative Electrode Active Material Unit)

The paste for the negative electrode active material layer with a thickness of 5 μm was printed on the sheet for the above described solid electrolyte layer by the screen printing. The printed paste was dried for 10 minutes at 80° C. Next, the paste for the negative electrode current collector layer with a thickness of 5 μm was printed thereon by the screen printing. The printed paste was dried for 10 minutes at 80° C. The paste for the negative electrode active material layer with a thickness of 5 μm was printed again thereon by the screen printing. The printed paste was dried for 10 minutes at 80° C.

Next, the PET film was separated. Thus, the sheet of the negative electrode active material unit was obtained in which the paste for the negative electrode active material layer, the paste for the negative electrode current collector layer, and the paste for the negative electrode active material layer were printed and dried in this order on the sheet for the solid electrolyte.

### (Manufacture of Stacked Body)

The positive electrode active material layer unit and the negative electrode active material layer unit were stacked so that the paste for the positive electrode active material layer, the paste for the positive electrode current collector layer, the paste for the positive electrode active material layer, the sheet for the solid electrolyte layer, the paste for the negative electrode active material layer, the paste for the negative electrode current collector layer, the paste for the negative electrode active material layer, and the sheet for the solid electrolyte layer were disposed in this order. On this occasion, the units were displaced so that the paste for the positive electrode current collector layer of the positive electrode active material unit extends to one end face only and the paste for the negative electrode current collector layer of the negative electrode active material unit extends to the other end face only. The sheet for the solid electrolyte layer was stacked on both surfaces of the stacked units so that the thickness became 500 μm. After that, this was molded by the thermal crimping method, and cut, thereby forming a stacking block. After that, the stacking block was fired at the same time to provide a stacked body. The firing was conducted in nitrogen in a manner that the temperature was increased up to a firing temperature of 840° C. at a temperature rising rate of 200° C./hour and then the temperature was maintained for two hours. The stacked body after firing was cooled naturally.

### (Step of Forming Terminal Electrode)

The terminal electrode paste was coated to the end face of the stacked body. By thermally curing the paste on the end face for 30 minutes at 150° C., a pair of terminal electrodes was formed. Thus, the lithium ion secondary battery was obtained.

### Example 1-2

A lithium ion secondary battery was manufactured by the same method as that in Example 1-1 except that the time of wet pulverizing using the ball mill was changed to 12 hours and the average particle diameter of the powder was 1.0 μm in the preparation of the solid electrolyte.

### Example 1-3

A lithium ion secondary battery was manufactured by the same method as that in Example 1-1 except that the time of wet pulverizing using the ball mill was changed to 8 hours and the average particle diameter of the powder was 1.6 μm in the preparation of the solid electrolyte.

### Example 1-4

A lithium ion secondary battery was manufactured by the same method as that in Example 1-1 except that the time of wet pulverizing using the ball mill was changed to 4 hours and the average particle diameter of the powder was 2.0 μm in the preparation of the solid electrolyte.

### Comparative Example 1-1

A lithium ion secondary battery was manufactured by the same method as that in Example 1-1 except that the time of wet pulverizing using the ball mill was changed to 24 hours and the average particle diameter of the powder was 0.2 μm in the preparation of the solid electrolyte.

### Comparative Example 1-2

A lithium ion secondary battery was manufactured by the same method as that in Example 1-1 except that the time of wet pulverizing using the ball mill was changed to 21 hours and the average particle diameter of the powder was 0.4 μm in the preparation of the solid electrolyte.

### Comparative Example 1-3

A lithium ion secondary battery was manufactured by the same method as that in Example 1-1 except that the time of wet pulverizing using the ball mill was changed to 2 hours and the average particle diameter of the powder was 2.4 μm in the preparation of the solid electrolyte.

### Example 2-1

A lithium ion secondary battery was manufactured by the same method as that in Example 1-1 except that the powder of LiVOPO₄ with an average particle diameter of 0.6 μm was used as the positive electrode active material.

### Example 2-2

A lithium ion secondary battery was manufactured by the same method as that in Example 1-2 except that the powder of LiVOPO₄ with an average particle diameter of 1.0 μm was used as the positive electrode active material.

### Example 2-3

A lithium ion secondary battery was manufactured by the same method as that in Example 1-3 except that the powder of LiVOPO₄ with an average particle diameter of 1.6 μm was used as the positive electrode active material.

### Example 2-4

A lithium ion secondary battery was manufactured by the same method as that in Example 1-4 except that the powder of LiVOPO₄ with an average particle diameter of 2.0 μm was used as the positive electrode active material.

### Comparative Example 2-1

A lithium ion secondary battery was manufactured by the same method as that in Comparative Example 1-1 except that the powder of LiVOPO₄ with an average particle diameter of 0.2 μm was used as the positive electrode active material.

### Comparative Example 2-2

A lithium ion secondary battery was manufactured by the same method as that in Comparative Example 1-2 except that the powder of LiVOPO₄ with an average particle diameter of 0.4 μm was used as the positive electrode active material.

### Comparative Example 2-3

A lithium ion secondary battery was manufactured by the same method as that in Comparative Example 1-3 except that the powder of LiVOPO₄ with an average particle diameter of 2.4 μm was used as the positive electrode active material.

### Example 3-1

A lithium ion secondary battery was manufactured by the same method as that in Example 1-1 except that the powder of LiCoO₂ with an average particle diameter of 0.2 μm was used as the positive electrode active material and the powder of Li₄Ti₅O₁₂ with an average particle diameter of 0.6 μm was used as the negative electrode active material.

### Example 3-2

A lithium ion secondary battery was manufactured by the same method as that in Example 1-2 except that the powder of LiCoO₂ with an average particle diameter of 0.2 μm was used as the positive electrode active material and the powder of Li₄Ti₅₁₂ with an average particle diameter of 1.0 μm was used as the negative electrode active material.

### Example 3-3

A lithium ion secondary battery was manufactured by the same method as that in Example 1-3 except that the powder of LiCoO₂ with an average particle diameter of 0.2 μm was used as the positive electrode active material and the powder of Li₄Ti₅O₁₂ with an average particle diameter of 1.6 μm was used as the negative electrode active material.

### Example 3-4

A lithium ion secondary battery was manufactured by the same method as that in Example 1-4 except that the powder of LiCoO₂ with an average particle diameter of 0.2 μm was used as the positive electrode active material and the powder of Li₄Ti₅O₁₂ with an average particle diameter of 2.0 μm was used as the negative electrode active material.

### Comparative Example 3-1

A lithium ion secondary battery was manufactured by the same method as that in Comparative Example 1-1 except that powder of LiCoO₂ with an average particle diameter of 0.2 μm was used as the positive electrode active material and the powder of Li₄Ti₅O₁₂ with an average particle diameter of 0.2 μm was used as the negative electrode active material.

### Comparative Example 3-2

A lithium ion secondary battery was manufactured by the same method as that in Comparative Example 1-2 except that powder of LiCoO₂ with an average particle diameter of 0.2 μm was used as the positive electrode active material and the powder of Li₄Ti₅O₁₂ with an average particle diameter of 0.4 μm was used as the negative electrode active material.

### Comparative Example 3-3

A lithium ion secondary battery was manufactured by the same method as that in Example 3-1 except that the powder of LiCoO₂ with an average particle diameter of 2.4 μm was used as the positive electrode active material.

### (Evaluation of Batteries)

A lead wire was connected to the terminal electrode of each of the manufactured lithium ion secondary batteries and then repeated charging/discharging tests were conducted under the measurement conditions below. The current at the charging and discharging was 2.0 μA. The cutoff voltage at the charging and discharging was 4.0 V and 0 V, respectively. The internal resistance calculated from the discharge capacity and the voltage drop at the start of the discharging in the fifth cycle is shown in Table 1.

Table 1 also shows the particle diameters of the solid electrolyte, the positive electrode active material, and the negative electrode active material after firing. Moreover, the ratio of the particle diameter of the solid electrolyte to the particle diameter of the positive electrode active material and the ratio of the particle diameter of the solid electrolyte to the particle diameter of the negative electrode active material are also shown. Note that the particle diameters of the solid electrolyte, the positive electrode active material, and the negative electrode active material are obtained by analyzing the sectional image of the lithium ion secondary battery taken with the scanning electron microscope or the like. In other words, assuming the shape of the particle based on the area of the particle in the image be a circle, the diameter of the circle, i.e., the equivalent circle diameter thereof was calculated. The number of pieces of data to be measured was 300. In the evaluation, the average value of the equivalent circle diameter obtained by the measurement was used as the particle diameter.

It has been known that, out of the internal resistance of the lithium ion secondary battery entirely formed of solid, i.e., the all-solid battery, the resistance caused by the interface between particles, i.e., the interface resistance is much larger than the ion transfer resistance inside the particle. Thus, the evaluation on the internal resistance shown in Table 1 can be treated as the evaluation on the internal resistance.

TABLE 1

| | | | | Particle | | | Particle | | |
|---|---|---|---|---|---|---|---|---|---|
| | | | Particle | diameter | | Particle | diameter | | |
| | | | diameter | ratio of solid | | diameter of | ratio of solid | | |
| | Particle | | of positive | electrolyte | | negative | electrolyte | | |
| | diameter | Positive | electrode | to positive | Negative | electrode | to negative | | |
| | of solid | electrode | active | electrode | electrode | active | electrode | Discharge | Internal |
| | electrolyte | active | material | active | active | materia | active | capacity | resistance |
| | [μm] | material | [μm] | material | material | [μm] | material | [μ A] | [k Ω] |
| Example 1-1 | 1.2 | Li₃V₂(PO₄)₃ | 0.4 | 3.0 | Li₃V₂(PO₄)₃ | 0.4 | 3.0 | 2.3 | 170 |
| Example 1-2 | 2.0 | Li₃V₂(PO₄)₃ | 0.4 | 5.0 | Li₃V₂(PO₄)₃ | 0.4 | 5.0 | 2.9 | 136 |
| Example 1-3 | 3.2 | Li₃V₂(PO₄)₃ | 0.4 | 8.0 | Li₃V₂(PO₄)₃ | 0.4 | 8.0 | 3.6 | 83 |
| Example 1-4 | 4.0 | Li₃V₂(PO₄)₃ | 0.4 | 10.0 | Li₃V₂(PO₄)₃ | 0.4 | 10.0 | 4.0 | 62 |
| Comparative | 0.4 | Li₃V₂(PO₄)₃ | 0.4 | 1.0 | Li₃V₂(PO₄)₃ | 0.4 | 1.0 | 0.6 | 550 |
| Example 1-1 | | | | | | | | | |
| Comparative | 0.8 | Li₃V₂(PO₄)₃ | 0.4 | 2.0 | Li₃V₂(PO₄)₃ | 0.4 | 2.0 | 0.7 | 528 |
| Example 1-2 | | | | | | | | | |
| Comparative | 4.8 | Li₃V₂(PO₄)₃ | 0.4 | 12.0 | Li₃V₂(PO₄)₃ | 0.4 | 12.0 | 0.8 | 440 |
| Example 1-3 | | | | | | | | | |
| Example 2-1 | 1.2 | LiVOPO₄ | 1.2 | 1.0 | Li₃V₂₍PO₄)₄ | 0.4 | 3.0 | 2.0 | 182 |
| Example 2-2 | 2.0 | LiVOPO₄ | 2.0 | 1.0 | Li₃V₂(PO₄)₅ | 0.4 | 5.0 | 2.7 | 156 |
| Example 2-3 | 3.2 | LiVOPO₄ | 3.2 | 1.0 | Li₃V₂(PO₄)₆ | 0.4 | 8.0 | 3.2 | 98 |
| Example 2-4 | 4.0 | LiVOPO₄ | 4.0 | 1.0 | Li₃V₂(PO₄)₆ | 0.4 | 10.0 | 3.5 | 80 |
| Comparative | 0.4 | LiVOPO₄ | 0.4 | 1.0 | Li₃V₂(PO₄)₆ | 0.4 | 1.0 | 0.3 | 763 |
| Example 2-1 | | | | | | | | | |
| Comparative | 0.8 | LiVOPO₄ | 0.8 | 1.0 | Li₃V₂(PO₄)₆ | 0.4 | 2.0 | 0.7 | 421 |
| Example 2-2 | | | | | | | | | |
| Comparative | 4.8 | LiVOPO₄ | 4.8 | 1.0 | Li₃V₂(PO₄)₆ | 0.4 | 12.0 | 0.2 | 842 |
| Example 2-3 | | | | | | | | | |
| Example 3-1 | 1.2 | LiCoO₂ | 0.4 | 3.0 | Li₄Ti₅O₁₂ | 1.2 | 1.0 | 2.0 | 184 |
| Example 3-2 | 2.0 | LiCoO₂ | 0.4 | 5.0 | Li₄Ti₅O₁₂ | 2.0 | 1.0 | 2.7 | 153 |
| Example 3-3 | 3.2 | LiCoO₂ | 0.4 | 8.0 | Li₄Ti₅O₁₂ | 3.2 | 1.0 | 3.2 | 108 |
| Example 3-4 | 4.0 | LiCoO₂ | 0.4 | 10.0 | Li₄Ti₅O₁₂ | 4.0 | 1.0 | 3.4 | 99 |
| Comparative | 0.4 | LiCoO₂ | 0.4 | 1.0 | Li₄Ti₅O₁₂ | 0.4 | 1.0 | 0.3 | 703 |
| Example 3-1 | | | | | | | | | |
| Comparative | 0.8 | LiCoO₂ | 0.4 | 2.0 | Li₄Ti₅O₁₂ | 0.8 | 1.0 | 0.5 | 465 |
| Example 3-2 | | | | | | | | | |
| Comparative | 4.8 | LiCoO₂ | 0.4 | 12.0 | Li₄Ti₅O₁₂ | 4.8 | 1.0 | 0.1 | 1080 |
| Example 3-3 | | | | | | | | | |

According to Table 1, the internal resistance has decreased and the discharge capacity has increased in the lithium ion secondary batteries in Examples 1-1 to 1-4 as compared to the lithium ion secondary batteries in Comparative Examples 1-1 and 1-2. It is considered that these results are based on the fact that the contact area between the solid electrolyte and the positive electrode active material and the negative electrode active material is increased due to the presence of the positive electrode active material and the negative electrode active material with small particle diameters between the solid electrolyte. In other words, this has decreased the internal resistance of the lithium ion secondary battery. On the other hand, the internal resistance has increased and the discharge capacity has decreased in the lithium ion secondary battery in Comparative Example 1-3 where the particle diameter ratio between the solid electrolyte and the positive electrode active material is larger than that in Examples 1-1 to 1-4. Further, crack was observed in the lithium ion secondary battery after firing in Comparative Example 1-3. Based on these facts, it is considered that crack has occurred in firing because the difference in heat shrinkage behavior between the solid electrolyte and the positive electrode active material by firing is increased due to the very large difference in particle diameter between the solid electrolyte and the positive electrode active material. The above results indicate that when the particle diameter ratio of the solid electrolyte to the positive electrode active material is in the range of 3.0 to 10.0, the lithium ion secondary battery exhibits the excellent performance.

The particle diameter ratio of the solid electrolyte to the positive electrode active material LiVOPO₄ is 1 in each of Examples 2-1 to 2-4 and Comparative Examples 2-1 to 2-3. Just the particle diameter ratio of the solid electrolyte to the negative electrode active material Li₃V₂(PO₄)₃ is different. The lithium ion secondary battery according to each of Examples 2-1 to 2-4 where the particle diameter ratio of the solid electrolyte to the negative electrode active material is in the range of 3.0 to 10.0 has the lower internal resistance and higher discharge capacity than the lithium ion secondary battery according to Comparative Examples 2-1 to 2-3. The above results indicate that when the particle diameter ratio of the solid electrolyte to at least one of the positive electrode active material and the negative electrode active material is in the range of 3.0 to 10.0, the effect of reducing the interface resistance of the lithium ion secondary battery can be obtained.

In Examples 3-1 to 3-4 and Comparative Examples 3-1 to 3-3, the positive electrode active material is LiCoO₂ and the negative electrode active material is Li₄Ti₅O₁₂. The lithium ion secondary battery according to each of Examples 3-1 to 3-4 where the particle diameter ratio of the solid electrolyte to the positive electrode active material is in the range of 3.0 to 10.0 has the lower internal resistance and higher discharge capacity than the lithium ion secondary battery according to each of Comparative Examples 3-1 to 3-3. It is understood that these results indicate the effect of the lithium ion secondary battery according to the present disclosure does not depend on any of the kind of the positive electrode active material or the kind of the negative electrode active material. In other words, the effect of reducing the interface resistance of the lithium ion secondary battery can be obtained as long as the particle diameter ratio of the solid electrolyte to at least one of the positive electrode active material and the negative electrode active material is in the range of 1/10 to 1/3.

The sectional image of the lithium ion secondary battery before firing according to Example 1-4 is shown below. The positive electrode active material powder had an average particle diameter of 0.2 μm and the solid electrolyte powder had an average particle diameter of 2.0 μm. Before firing, the positive electrode active material powder and the negative electrode active material powder with small particle diameters are already disposed between the solid electrolyte powder with large particle diameter. The observation thereon indicates that the contact area between the positive electrode active material powder and the solid electrolyte powder and the contact area between the negative electrode active material powder and the solid electrolyte powder are increased. After firing, the large contact area between the positive electrode active material and the solid electrolyte and the large contact area between the negative electrode active material and the solid electrolyte are maintained. Therefore, the internal resistance of the lithium ion secondary battery is reduced.

The lithium ion secondary battery according to the embodiment of the present disclosure may be the following first or second lithium ion secondary battery.

A first lithium ion secondary battery is a lithium ion secondary battery including a solid electrolyte layer between a positive electrode layer and a negative electrode layer. The positive electrode layer includes a positive electrode current collector layer and a positive electrode active material layer. The negative electrode layer includes a negative electrode current collector layer and a negative electrode active material layer. The solid electrolyte layer is positioned between the positive electrode active material layer and the negative electrode active material layer. A ratio of a solid electrolyte included in the solid electrolyte layer to any one of a positive electrode active material and a negative electrode active material included in the positive electrode active material layer and the negative electrode active material layer ((particle diameter of solid electrolyte)/(particle diameter of positive electrode active material or particle diameter of negative electrode active material)) is in the range of 3.0 to 10.0.

In a second lithium ion secondary battery according to the first lithium ion secondary battery, the solid electrolyte layer includes Li₁₊ₓAlₓTi₂₋ₓ(PO₄)₃ (0 ≦x≦0.6). Either or both of the positive electrode active material layer and the negative electrode active material layer is either or both of LiVOPO₄ and Li₃V₂(PO₄)₃.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A lithium ion secondary battery comprising a positive electrode layer, a negative electrode layer, and a solid electrolyte layer, wherein:
the positive electrode layer includes a positive electrode current collector layer and a positive electrode active material layer;
the positive electrode active material layer includes a positive electrode active material;
the negative electrode layer includes a negative electrode current collector layer and a negative electrode active material layer;
the negative electrode active material layer includes a negative electrode active material;
the solid electrolyte layer is positioned between the positive electrode active material layer and the negative electrode active material layer and includes a solid electrolyte; and
at least one of a ratio of a particle diameter of the solid electrolyte to a particle diameter of the positive electrode active material and a ratio of the particle diameter of the solid electrolyte to a particle diameter of the negative electrode active material is in the range of 3.0 to 10.0.

2. The lithium ion secondary battery according to claim 1, wherein:
the solid electrolyte layer includes Li₁₊ₓAlₓTi₂₋ₓ(PO₄)₃ (0≦x≦0.6); and
the positive electrode active material layer includes at least one of LiVOPO₄ and Li₃V₂(PO₄)₃.

3. The lithium ion secondary battery according to claim 1, wherein:
the solid electrolyte layer includes Li₁₊ₓAlₓTi₂₋ₓ(PO₄)₃ (0≦x≦0.6); and
the negative electrode active material layer includes at least one of LiVOPO₄ and Li₃V₂(PO₄)₃.

4. The lithium ion secondary battery according to claim 1, wherein:
the solid electrolyte layer includes Li₁₊ₓAlₓTi₂₋ₓ(PO₄)₃ (0≦x≦0.6); and
the positive electrode active material layer and the negative electrode active material layer include at least one of LiVOPO₄ and Li₃V₂(PO₄)₃.
